(19) United States
(12) Patent Application Publication
(10) Pub. No.: US 2009/0229718 A1
(43) Pub. Date: Sep. 17, 2009

(54) Tire for two-wheeler

(76) Inventors: Alain Valle, Cebazat (FR); Pascal Prost, Riom (FR)

Correspondence Address: COHEN, PONTANI, LIEBERMAN & PAVANE LLP, 551 FIFTH AVENUE, SUITE 1210, NEW YORK, NY, 10176, US

(21) Appl. No.: 11/921,144

(22) PCT Filed: May 22, 2006
(86) PCT No.: PCT/EP2006/062498

§ 371 Date: Nov. 26, 2007

(30) Foreign Application Priority Data
May 24, 2005 (FR) 050232

(51) Int. Cl. B60C 11/00

(52) U.S. Cl. 152/185.1

(57) ABSTRACT

A tire for a motorized two-wheeled vehicle and more particularly for a motorcycle. A tire such as this comprises at least one reinforcing structure of the carcass type, formed of reinforcing elements, anchored on each side of the tire into a bead the base of which is intended to be mounted on a rim seat, each bead extending radially outwards in the form of a sidewall, the sidewalls radially towards the outside meeting a tread, and comprising, under the tread, a crown reinforcing structure made up of at least one layer of reinforcing elements termed the working layer. At least locally, the tread comprises a first polymer compound and of at least one second polymer compound having physico-chemical properties different from those of the said first polymer compound, at least 75% of the volume of the tread consisting of the first polymer compound, and the second polymer compound being distributed discretely.

The present invention relates to a tire intended to be fitted to a vehicle and more particularly intended to be fitted to a two-wheeled vehicle such as a motorcycle.

Although not restricted to such an application, the invention will be more particularly described with reference to such a motorcycle or motorbike tire.

The body plies which reinforce tires and particularly motorcycle tires currently—and usually—consist of stacks of one or more plies conventionally termed “carcass plies”, “crown plies”, etc. This way of naming the body plies stems from the manufacturing method which consists in producing a series of semi-finished products in the form of plies, provided with thread-formed reinforcements, often longitudinal ones, which are later assembled or stacked to form a tire preform. The plies are produced in the flat state, with significant dimensions, and are then cut to suit the dimensions of a given product. The plies are also, in an initial stage, assembled in a substantially flat state. The preform thus produced is then shaped to adopt the toroidal profile typical of tires. The semi-finished so-called “finishing” products are then applied to the preform, to obtain a product ready to be cured.

A “conventional” type of method such as this involves, particularly in the phase of manufacturing the tire preform, the use of an anchoring element (generally a bead wire) used to anchor or hold the carcass in the region of the beads of the tire. Thus, in this type of method, a portion of all the plies that make up the carcass (or just some of them) is or are wrapped around a bead wire positioned in the bead of the tire. Thus the carcass is anchored into the bead.

The fact that this conventional type of method is widespread throughout the tire-manufacturing industry, in spite of there being numerous alternative ways of producing the plies and the assemblies, has led those skilled in the art to employ a vocabulary hinged on the method: hence the terminology generally accepted which in particular includes the terms “plies”, “carcass”, “bead wire”, “shaping” to denote the change from a flat profile to a toroidal profile, etc.

Nowadays there are tires which do not strictly speaking have any “plies” or “bead wires” consistent with the above definitions. For example, document EP 0 582 196 describes tires manufactured without the use of semi-finished products in the form of plies. For example, the reinforcing elements of the various reinforcing structures are applied directly to the adjacent layers of rubber compounds, all of this being applied in successive layers to a toroidal core the shape of which allows a profile similar to the final profile of the tire being manufactured to be obtained directly.

Thus, in this case, there are no longer any “semi-finished” products or any “plies”, or any “bead wires”. The base products, such as the rubber compounds and the reinforcing elements in the form of threads or filaments are applied directly to the core. Since this core is of toroidal shape, there is no longer any need to shape the preform in order to change from a flat profile to a profile in the shape of a torus.

Furthermore, the tires described in that document do not have any “traditional” wrapping of the carcass ply around a bead wire. That type of anchorage is replaced by an arrangement whereby circumferential threads are positioned adjacent to the said sidewall reinforcing structure, everything being embedded in an anchoring or bonding rubber compound.

There are also methods of assembly onto a toroidal core that employ semi-finished products specially adapted for rapid, effective and simple placement on a central core. Finally, it is also possible to use a hybrid comprising both certain semi-finished products for achieving certain architectural aspects (such as plies, bead wires, etc.) while others are achieved by applying compounds and/or reinforcing elements directly.

In this document, in order to take account of recent technological evolutions both in the field of manufacture and in the design of the products, the conventional terms such as “plies”, “bead wires”, etc., are advantageously replaced with terms that are neutral or independent of the type of method used. Thus, the term “carcass-type reinforcement” or “sidewall reinforcement” can be used to denote the reinforcing elements of a carcass ply in the conventional method, and the corresponding reinforcing elements, generally applied to the sidewalls, of a tire produced using a method that does not involve semi-finished products. The term “anchoring region” for its part, can denote the “traditional” wrapping of the carcass ply around a bead wire in a conventional method just as easily as it can denote the assembly formed by the circumferential reinforcing elements, the rubber compound and the adjacent sidewall reinforcing portions of a bottom region produced using a method that involves application onto a toroidal core.

As in the case with all other tires, motorbike tires are tending towards a radial design, the architecture of such tires involving a carcass formed of one or two layers of reinforcing elements that make an angle possibly of between 65° and 90° with respect to the circumferential direction, the said carcass being radially surmounted by a crown reinforcement formed at least of reinforcing elements generally made of textiles. Nonetheless, there do remain some non-radial tires to which the invention also relates. The invention also relates to partially radial tires, that is to say tires in which the carcass reinforcing elements are radial over at least part of the said carcass, for example in the part corresponding to the crown of the tire.

Numerous crown reinforcement architectures have been proposed, depending on whether the tire is intended to be fitted to the front of the motorbike or to the rear. A first structure consists, in the case of the said crown reinforcement, in using only circumferential cords, and the said structure is more particularly used for the rear tire. A second structure, which takes its inspiration directly from the structures currently used on passenger vehicle tires, has been used to improve the resistance to wear and consists in using at least two crown layers of reinforcing elements which are mutually parallel within each layer but crossed from one layer to the next, making acute angles with respect to the circumferential direction, such tires being more particularly suited to the front wheel of motorbikes. The said two crown layers may be associated with at least one layer of circumferential elements, generally obtained by helically winding a strip of at least one rubber-coated reinforcing element.

Patent FR 2 561 588 thus describes such a crown reinforcement, with at least one ply the reinforcing elements of which make an angle that can vary between 0° and 8° with respect to the circumferential direction, the elastic modulus of such elements being as high as at least 6000 N/mm² and, positioned between the carcass and the ply made up of circumferential elements, a cushioning layer formed mainly of two plies of elements which are crossed from one ply to the next, making angles of between 60° and 90° with respect to one another, the said crossed plies being formed of textile reinforcing elements with an elastic modulus of at least 6000 N/mm².

Document EP 0 456 933, with a view to giving a motorbike tire excellent high-speed stability and excellent ground-contact properties, teaches, for example, how to build a crown reinforcement with at least two plies: a first ply, radially closest to the carcass being made up of cords orientated at an angle of between 40° and 90° with respect to the circumferential direction and the second ply, radially closest to the tread, being made up of cords helically wound in the circumferential direction.

U.S. Pat. No. 5,301,730, with a view to increasing the traction of a tire for a motorbike rear wheel, proposes a crown reinforcement made up, from the radial carcass out to the tread, of at least one ply of substantially circumferential elements and two plies of elements which are crossed from one ply to the next, making an angle that may range from 35° and 55° with respect to the circumferential direction, the ply of elements parallel to the circumferential direction possibly being formed of elements made of aromatic polyamide, and the plies of crossed elements of aliphatic polyamide.

As far as the tread of these tires is concerned, it is known that, in order to improve the grip of the tire, the very nature of the rubber compound that comes into contact with the said roadway has an appreciable effect. However, in parallel with this improvement in grip performance, there is usually a drop in wear-resistance performance, which manifests itself in a shorter wear life and requires the tires of a vehicle to be changed more frequently.

The production of treads comprising three regions distributed axially so as to impart different properties in terms of wear rate and grip is known, particularly from document FR 1 445 678. This type of embodiment is advantageous but usually the advantages obtained are restricted to one given type of use.

The longitudinal direction of the tire, or circumferential direction, is the direction corresponding to the periphery of the tire and defined by the direction in which the tire runs.

A circumferential plane or a circumferential section plane is a plane perpendicular to the axis of rotation of the tire. The equatorial plane is the circumferential plane that passes through the centre or crown of the tread.

The transverse or axial direction of the tire is parallel to the axis of rotation of the tire.

A radial plane contains the axis of rotation of the tire.

It is an object of the invention to produce tires, particularly for motorcycles, combining satisfactory grip and wear rate properties irrespective of the type of use, particularly irrespective of whether the motorcycle is essentially running in a straight line or following a winding path, and especially, when doing so on wet ground.

This objective has been achieved according to the invention using a tire comprising at least one reinforcing structure of the carcass type, formed of reinforcing elements, anchored on each side of the tire into a bead the base of which is intended to be mounted on a rim seat, each bead extending radially outwards in the form of a sidewall, the sidewalls radially towards the outside meeting a tread, the said tread, at least locally, consisting predominantly of a first polymer compound and of at least one second polymer compound having physico-chemical properties different from those of the said first polymer compound, at least 75% of the volume of the tread being made up of the first polymer compound, the second polymer compound being distributed discretely and the maximum value of tan δ at 40° C. for the second compound being at least 10% higher than the maximum value of tan δ for the first compound.

According to a preferred embodiment, the volume of the second compound is greater than 3% of the volume of the tread.

Also as a preference, the discretely-distributed second compound is present in the form of inclusions of which the dimension in the circumferential direction measures 5 mm at most.

As a preference too, the discretely-distributed second compound is present in the form of inclusions of which the dimension in the axial direction measures 0.5 mm at most.

Alternative forms of embodiment of the invention advantageously anticipate that the second compound is present at least partially over at least part of the exterior surface of the tread.

As a preference too, the difference in complex modulus (AG*) of the second compound is at least 10% higher than the difference in complex modulus (ΔG*) of the first compound.

The dynamic properties ΔG* and tan δₘₐₓ are measured on a viscoanalyser (Metravib VA4000) in accordance with standard ASTM D 5992-96. The response of a specimen of vulcanized tire compound (a cylindrical test specimen 4 mm thick and with a cross-sectional area of 400 mm²), subjected to simple sinusoidal reverse shear stress cycles at a frequency of 10 Hz under normal temperature conditions (23° C.) in accordance with the standard ASTM D 1349-99, or, as the case may be, at a different temperature, are recorded. The outbound cycle involves sweeping through amplitudes of deformation ranging from 0.1 to 50%, then the return cycle sweeps through amplitudes of deformation from 50% to 1%. The results used are the dynamic shear complex modulus (G*) and the loss factor tan δ. On the return cycle, the observed maximum value of tan δ, denoted tan δₘₐₓ, and the difference in complex modulus ΔG* between the values for 0.15% deformation and 50% deformation (Payne effect) are recorded.

According to a preferred embodiment of the invention, the second polymer compound is of a composition that differs from that of the first polymer compound and, as a further preference, the second polymer compound has adhesion properties superior to those of the said first polymer compound.

According to other embodiments, different properties may be obtained with identical compounds using different curing conditions.

The invention thus defined makes it possible to produce a tire the tread of which may be made up of a first polymer compound chosen in particular for its wear-resistance properties and in which incrustations of a second polymer compound with other properties such as enhanced grip properties, particularly on wet ground, appear on the surface of the tread. The dimension and distribution of the said incrustations will define a percentage of the said second polymer compound in the area of contact between the tread and the ground. The combination of these two polymer compounds will make it possible to form a tread which, on the one hand, exhibits satisfactory resistance to wear on account of the vastly predominant first compound and, on the other hand, grip properties that are enhanced through the presence of the second polymer compound. The inventors have actually been able to demonstrate, particularly in tests, that a small surface quantity of the second compound in the contact area and advantageously distributed homogeneously is enough to afford a very substantial improvement in the grip of the tire.

According to the invention, the second polymer compound has a Shore A hardness different from that of the first polymer compound.

The Shore A hardness of the polymer compounds after curing is assessed in accordance with standard ASTM D 2240-86.

Other properties of the second polymer compound may be different. These may, for example, involve the color which may have a functional and/or aesthetic purpose; it may, for example, then act as a visual wear indicator.

A first alternative embodiment of the invention anticipates that the second polymer compound is distributed in such a way that, in at least one circumferential plane of the tire, at least one given radial distance from the exterior surface of the tread, at least one physico-chemical property of the polymer mass of the tread varies in the circumferential direction.

According to this first alternative form of embodiment, the invention anticipates that the second compound is distributed at the periphery of the tire, advantageously at the surface of the tread, in order to find a balance between wear rate and grip irrespective of the position of the tire in terms of rotation. According to this alternative form of embodiment of the invention, this circumferential distribution is to be found whatever the degree of wear of the tire, the said distribution being through the depth of the tread in order to take account of the said wearing of the tire as it is used.

A second alternative form of embodiment of the invention anticipates that the second polymer compound is distributed in such a way that, in at least one radial plane of the tire, at least one given radial distance from the exterior surface of the tread, at least one physico-chemical property of the polymer mass of the tread varies in the axial direction.

According to this second alternative form of embodiment, the invention anticipates that the second compound is distributed across the axial width of the tire advantageously at the surface of the tread in order to find a balance between wear rate and grip irrespective of the position of the tire in terms of camber. According to this alternative form of embodiment of the invention, this circumferential distribution may advantageously be found whatever the degree of wear of the tire, the distribution being through the depth of the tread in order to take account of the said wearing of the tire as it is used.

A third alternative form of embodiment of the invention anticipates that the second polymer compound is distributed in such a way that, in at least one radial plane of the tire and/or in at least one circumferential plane of the tire, at least one physico-chemical property of the polymer mass of the tread varies in the radial direction.

This third alternative form of embodiment of the invention advantageously anticipates a distribution of the two polymer compounds in the radial direction of the tire, that is to say in the depth of the tread of the tire. This alternative form of the invention therefore anticipates for the incrustations of the second polymer compound advantageously not to be continuous in the radial direction.

According to one or other of these alternative forms of embodiment, provision may be made for the second compound not to appear on the surface of the tread but locally to modify the properties thereof, for example on account of the two compounds having very different hysteresis properties.

According to one advantageous embodiment, the invention also anticipates combining two or more of these alternative forms.

According to the invention and depending on the intended use of the tire, it is thus for example possible to produce a tire in which the tread, consisting essentially of a first polymer compound, has incrustations of a second polymer compound over a limited part of the surface of the tread. This may, for example, be the axially exterior parts of the tread for use of the tire on a motorcycle with a camber angle in order to improve the grip in this type of use while at the same time maintaining satisfactory wear rates.

The invention also anticipates the possibility of introducing at least a third polymer compound distributed over the surface of the tread, for example in order to obtain variations in the grip properties gradually in the axial direction.

A third polymer compound may also be introduced into the tread at a level radially different from that at which the second polymer compound is introduced, for example in order to cause the grip properties to change with the degree of wear of the tread of the tire. Such a distribution of several polymer compounds through the thickness of the tread may also, for example, make it possible to create rigidity gradients within the thickness of the tread and these may also influence the grip properties of the tire.

According to one advantageous embodiment, the invention also anticipates that the tread comprises at least two circumferential strips, each of the circumferential strips consisting predominantly of a first polymer compound, the said first polymer compound differing from one circumferential strip to the other.

A tire obtained according to this embodiment may in particular make it possible to reach compromises between wear rate and grip which vary in the axial direction of the tire. Specifically, it is thus possible to produce a tire which, at the surface of the tread, has regions in which the first polymer compound is not the same, for example because wear rate requirements vary according to whether the tire is used in a straight line or whether it is used with a camber angle, each of these first compounds being incrusted with at least one second compound, it also being possible for the said second compound to vary from one region to another.

A tire according to the invention may in particular be produced in a technique using a hard core as described above. The manufacturing method then for example entails the use of at least a second means for distributing and positioning polymer when producing the tread. This may, for example, be a second tool, such as an extruder, as described in Patent EP 0 264 600 which is temporarily substituted for the first tool in order to lay a small amount of the second polymer compound.

A tire such as this which, as mentioned previously, is advantageously produced using a technique of the type involving a hard or toroidal core in particular allows the polymer compounds to be laid in almost their final position; this is because since a shaping step is not required in this type of method, the position of the polymer compounds does not vary once they have been laid. This type of method thus allows tires according to the invention to be produced with a perfect control of the laying and location of the various polymer compounds.

Advantageous, in the case of a radial structure, the reinforcing elements of the carcass-type reinforcing structure make an angle of between 65° and 90° with respect to the circumferential direction.

An advantageous embodiment of the invention also anticipates that the carcass-type reinforcing structure consists of two half-plies running for example from the shoulders to the beads. Depending on the nature, the quantity and the arrangement of the crown reinforcing elements, the invention effectively anticipates eliminating the carcass structure in at least part of that region of the tire that lies under the tread. Such a carcass structure can be produced according to the teachings of document EP-A-0 844 106.

According to a preferred embodiment of the invention, the crown reinforcing structure comprises at least two layers of reinforcing elements such that, from one layer to the next, the portions make angles of between 20 and 160° and preferably between 40 and 100° with one another.

Advantageously too, the crown reinforcing structure comprises at least one layer of circumferential reinforcing elements.

The reinforcing elements in the layer of circumferential reinforcing elements are preferably made of metal and/or textile and/or glass and preferably also have an elastic modulus in excess of 6000 N/mm².

The reinforcing elements in the working layers, the reinforcing elements of which are not directed circumferentially, are advantageously made of a textile material.

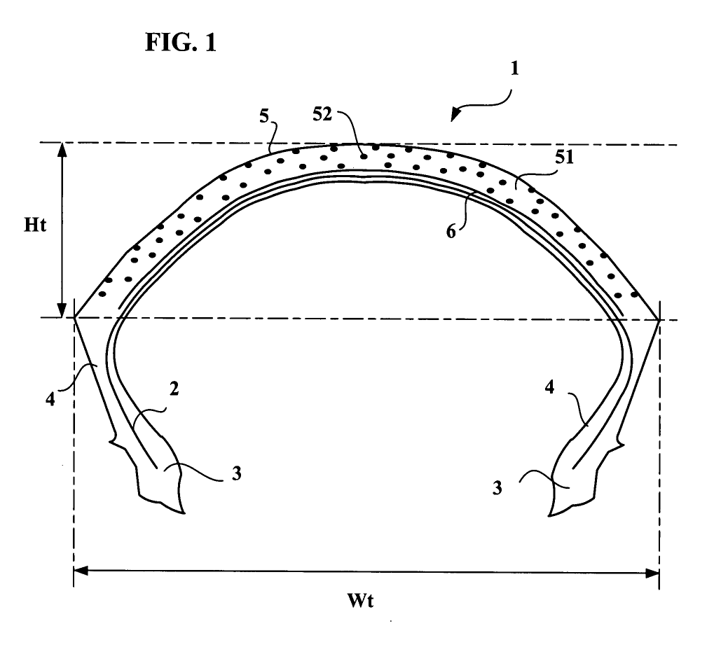

Other details and advantageous features of the invention will become apparent hereinafter from the description of some exemplary embodiments of the invention given with reference to FIGS. 1 to 5 which depict:

FIG. 1: a meridian view of a diagram of a tire according to a first embodiment of the invention;

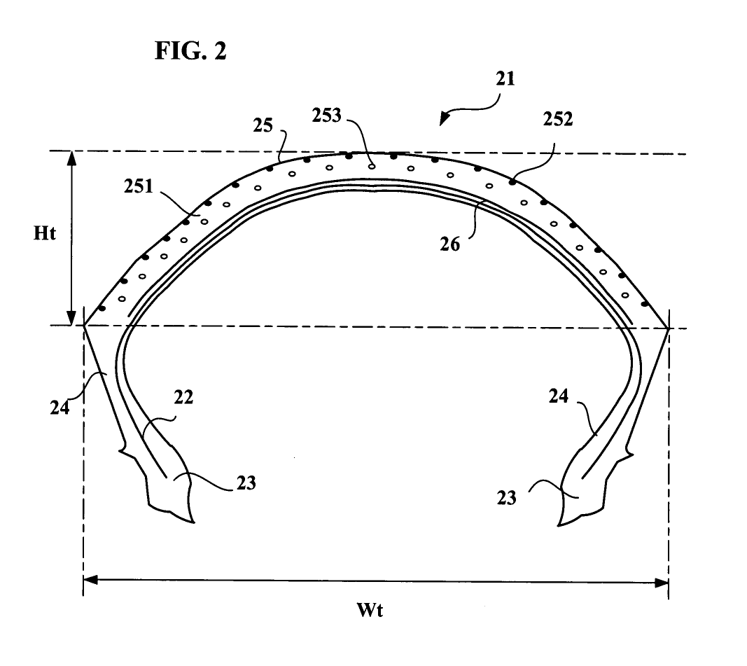

FIG. 2: a meridian view of a diagram of a tire according to a second embodiment of the invention;

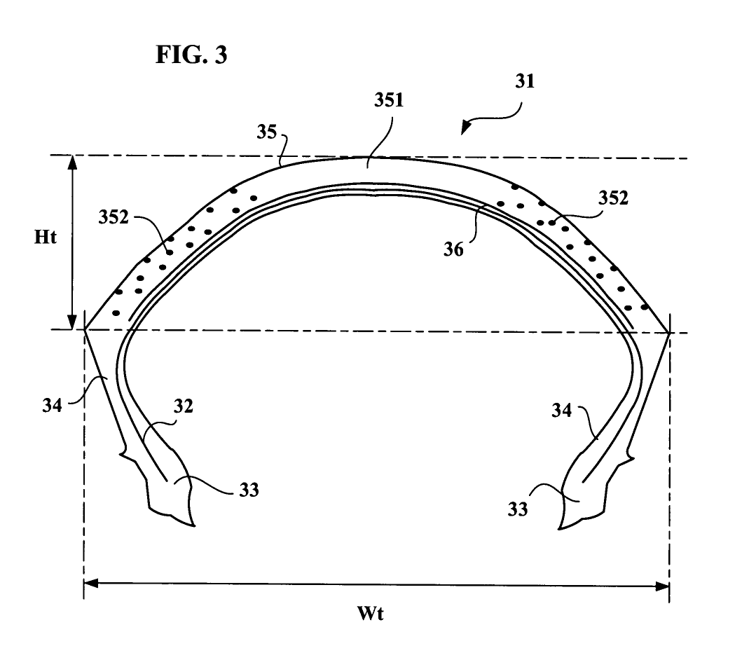

FIG. 3: a meridian view of a diagram of a tire according to a third embodiment of the invention;

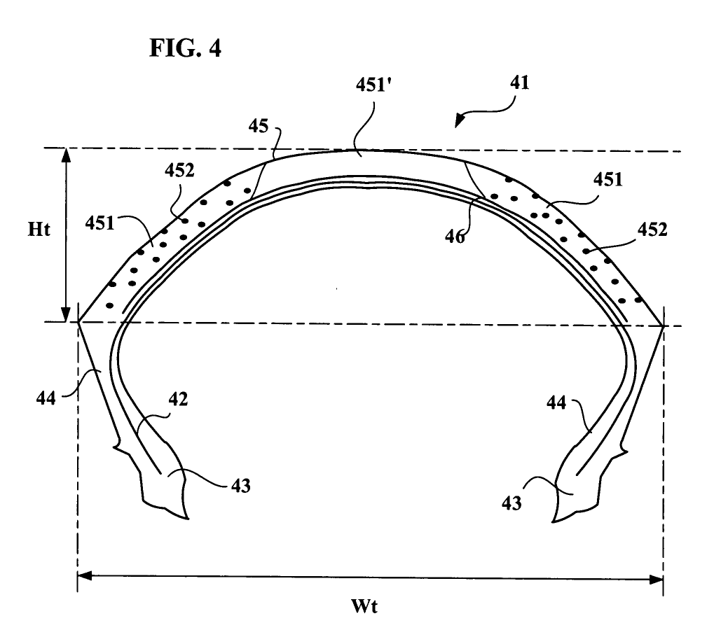

FIG. 4: a meridian view of a diagram of a tire according to a fourth embodiment of the invention; and

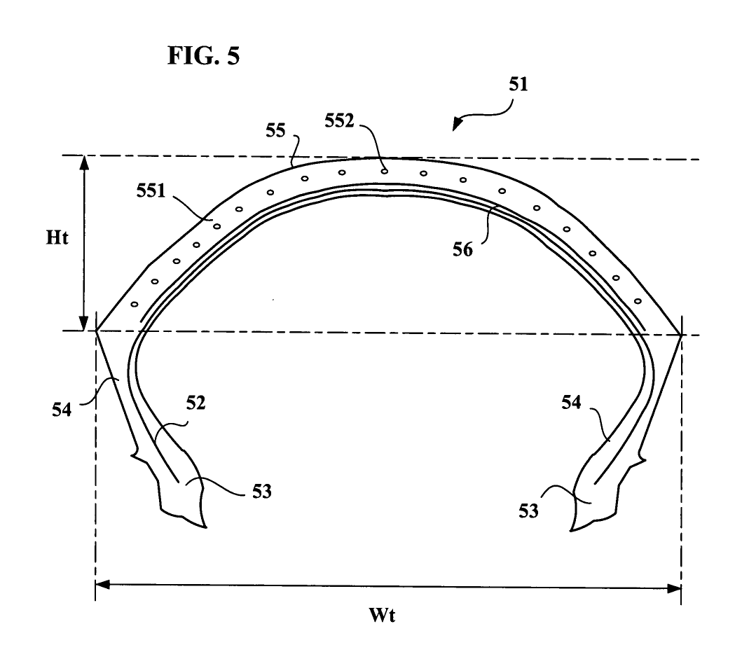

FIG. 5: a meridian view of a diagram of a tire according to a fifth embodiment of the invention.

For ease of understanding, FIGS. 1 to 5 are not drawn to scale.

FIG. 1 depicts a tire 1 comprising a carcass consisting of a layer 2 comprising reinforcing elements of textile type. The layer 2 is made up of reinforcing elements arranged radially. The radial positioning of the reinforcing elements is defined by the angle at which the said reinforcing elements are laid; a radial arrangement corresponds to the said elements being laid at an angle of between 65° and 90° with respect to the longitudinal direction of the tire.

The said carcass layer 2 is anchored on each side of the tire 1 in a bead 3 the base of which is intended to be mounted on a rim seat. Each bead 3 is extended radially outwards in the form of a sidewall 4, the said sidewall 4 radially towards the outside meeting a tread 5. The tire 1 thus formed has a curvature in excess of 0.15 and preferably in excess of 0.3. The curvature is defined by the ratio Ht/Wt, that is to say the ratio of the height of the tread to the maximum width of the tread of the tire. The curvature will advantageously range between 0.25 and 0.5 for a tire intended to be fitted on the front wheel of a motorcycle and will advantageously range between 0.2 and 0.5 for a tire intended to be fitted to the back wheel.

The tire 1 also comprises a crown reinforcement 6 which may, as the case may be, consist of at least two working layers comprising reinforcing elements that are mutually parallel within a given layer and are crossed from one layer to the next and/or of a layer of circumferential reinforcing elements.

Radially above the crown reinforcement 6 is the tread 5, which according to the invention is made up of a predominant first rubber compound 51 and of a second rubber compound 52. The second rubber compound 52 is present in the form of incrustations embedded in the first rubber compound 51. In the depiction of FIG. 1, the incrustations of the second rubber compound 52 are distributed over the entire tread in the axial direction and in the longitudinal direction. The depiction of FIG. 1 also anticipates the incrustations of the second rubber compound 52 being distributed in the radial direction. According to this embodiment of the invention, whatever the degree of wear of the tread, the percentage of the surface area of rubber compound 52 with respect to the total surface area of the tread is substantially the same.

The rubber compound 52 is advantageously chosen such that its grip properties are superior to those of the rubber compound 51, the said rubber compound 51 being more particularly chosen for its resistance to wear. The tread thus produced may make it possible to reach a wear resistance/grip compromise that is favorable over that which can be obtained with one rubber compound.

The dynamic properties ΔG* and tan δₘₐₓ measured in accordance with the aforementioned standards are as follows:

| Compound | tanδₘₐₓ | ΔG* |
|---|---|---|
| First compound (predominant) | 0.359 | 4.34 |
| Second compound (inclusions) | 0.731 | 11.39 |

FIG. 2 illustrates a second embodiment of a tire 21 according to the invention, in which the incrustations of two rubber compounds 252, 253 are embedded in a first rubber compound 251. The two rubber compounds 252, 253 are distributed through the tread in two distinct layers separated radially from one another so that they appear in succession as the tire wears. The rubber compound 253 may, for example, have grip properties even more superior to those of the rubber compound 252 in order to improve the grip of the tire as it ages.

The embodiment of tire 31 illustrated in FIG. 3 differs from the preceding ones in that the distribution of the incrustations of at least one second rubber compound 352 in the rubber compound 351 is not over the entire tread as far as the axial direction is concerned. In the longitudinal direction, the distribution remains advantageously substantially homogeneous so as to maintain identical properties over a turn of the wheel. An embodiment such as this in accordance with FIG. 3 may make it possible to improve the grip properties in those regions of the surface which are axially on the outside of the tread while at the same time maintaining essentially wear-resistant properties at the crown of the tread, in order respectively to take account of the use of a motorbike in a straight line and its use on a winding path which entails a significant camber angle of the tires.

FIG. 4 depicts a tire 41 according to the invention which, as in the case of FIG. 3, anticipates the incrustations of at least a second rubber compound 452 being distributed over one or more axial regions of the tread. This distribution is further combined with at least two main rubber compounds 451, 451′, also distributed in the axial direction. According to such an embodiment of the invention, it is thus possible to combine different properties of different first rubber compounds with the local presence of incrustations of at least one second rubber compound.

The embodiment of tire 51 illustrated in FIG. 5 differs from the preceding ones in that the distribution of the incrustations of at least one second rubber compound 552 in the rubber compound 551 is not over the entire tread as far as the radial direction is concerned. In the longitudinal direction, the distribution remains advantageously substantially homogeneous in order to maintain identical properties in one turn of the wheel. According to the depiction of FIG. 5, the incrustations of the second rubber compound 552 do not appear at the surface of the tread. This second rubber compound 552 may for example be chosen to exhibit very high hysteresis losses and thus allow local heating of the first rubber compound 551, particularly at the surface of the tread. This local heating of the surface of the tread may, for example, also allow the overall performance to be altered in terms of grip. An embodiment such as this according to FIG. 5 may therefore make it possible to improve the grip properties on regions of the surface axially on the outside of the tread while at the same time maintaining a good wear resistance.

The invention also anticipates combining one or more of the various embodiments of the invention as illustrated in each of the figures and, in particular, combining the presence over just one or more axial regions of the tread, possibly in combination with various first rubber compounds, with the presence of at least two second rubber compounds incorporated in the form of incrustations into the layers of the tread which are radially separated from one another.

The invention also anticipates either a random distribution of at least one second compound within the tread or an ordered and chosen distribution of the said at least second rubber compound. The latter alternative form of embodiment may in particular be achieved when the tire is produced using a technique of the type involving a hard core.

Tests have been carried out on motorcycles, of the 750 cc sports range, equipped with 120/70 ZR 17 front tires and with 180/55 ZR 17 rear tires. The inflation pressures are identical and equal to 2.5 bar.

The tests consisted in having the same rider ride the same motorbike fitted in succession with different tires and in measuring the time it took him to complete one lap of the circuit.

The control tires were tires the tread of which had just the first compound as discussed in the description of FIG. 1. Tests were conducted on new tires and then tires with 10% wear.

The tires according to the invention were produced according to the description of FIG. 1, the tread having inclusions representing 5% of the volume of the tread and 5% of the surface area of the said tread in the as-new condition and in the 10% worn condition.

The results are collated in the table below, a base line of 100 being taken for the time measured with a control tire in as-new condition:

| | Tire | | | |
|---|---|---|---|---|
| | Control | Control | Invention | Invention |
| | New condition | 10% worn | New condition | 10% worn |
| Time | 100 | 101 | 98 | 98 |

The results obtained can be interpreted as follows: values higher than 100 correspond to tires which are slower and therefore exhibit poorer grip. Values lower than 100 correspond to tires which are faster and therefore exhibit better grip.

The results obtained in the tests demonstrate first of all that the tires according to the invention do actually allow an improvement in grip properties. Furthermore, it is apparent from the tests conducted that the tires according to the invention make it possible to obtain grip properties that last better through the use of the tire as it wears.

1. A tire comprising at least one reinforcing structure of the carcass type, formed of reinforcing elements, anchored on each side of the tire into a bead the base of which is adapted to be mounted on a rim seat, each bead extending radially outwards in the form of a sidewall, the sidewalls radially towards the outside meeting a tread, wherein, at least locally, the tread consists predominantly of comprises a first polymer compound and at least one second polymer compound having physico-chemical properties different from those of the said first polymer compound, wherein at least 75% of the volume of the tread is made up of the first polymer compound, wherein the second polymer compound is distributed discretely, and in that wherein the maximum value of tan δ at 40° C. for the second compound is at least 10% higher than the maximum value of tan δ for the first compound.

2. The tire according to claim 1, wherein the volume of the second compound is greater than 3% of the volume of the tread.

3. The tire according to claim 1, wherein, the second compound is present in the form of inclusions of which the dimension in the circumferential direction measures at least 5 mm.

4. The tire according to claim 1, wherein the second compound is present in the form of inclusions of which the dimension in the axial direction measures 5 mm at most.

5. The tire according to claim 1, wherein the second compound is present at least partially over at least part of the exterior surface of the tread.

6. The tire according to claim 1, wherein the difference in complex modulus (ΔG*) of the second compound is at least 10% higher than the difference in complex modulus (ΔG*) of the first compound.

7. The tire according to claim 1, wherein the second polymer compound is of a composition that differs from that of the first polymer compound.

8. The tire according to claim 1, wherein the second polymer compound has adhesion properties superior to those of the said first polymer compound.

9. The tire according to claim 1, wherein the second polymer compound has a Shore A hardness different from that of the first polymer compound.

10. The tire according to claim 1, wherein the second polymer compound is distributed in such a way that, in at least one circumferential plane of the tire, at least one given radial distance from the exterior surface of the tread, at least one physico-chemical property of the polymer mass of the tread varies in the circumferential direction.

11. The tire according to claim 1, wherein the second polymer compound is distributed in such a way that, in at least one radial plane of the tire, at least one given radial distance from the exterior surface of the tread, at least one physico-chemical property of the polymer mass of the tread varies in the axial direction.

12. The tire according to claim 1, wherein the second polymer compound is distributed in such a way that, in at least one radial plane of the tire and/or in at least one circumferential plane of the tire, at least one physico-chemical property of the polymer mass of the tread varies in the radial direction.

13. The tire according to claim 1, wherein the tread comprises at least two circumferential strips and in that each of the circumferential strips consists predominantly of a first polymer compound, the said first polymer compound differing from one circumferential strip to the other.

14. The tire according to claim 1, wherein the reinforcing elements of the carcass-type reinforcing structure make an angle of between 65° and 90° with respect to the circumferential direction.

15. The tire according to claim 1, wherein the carcass-type reinforcing structure is made in two half-layers running from the shoulders to the beads.

16. The tire according to claim 1, comprising, under the tread, a crown reinforcing structure, wherein the crown reinforcing structure comprises at least two layers of reinforcing elements and in that, from one layer to the next, the portions make angles of between 20 and 160° with one another.

17. The tire according to claim 1, wherein the crown reinforcing structure comprises at least one layer of circumferential reinforcing elements.

18. The tire according to claim 17, wherein the reinforcing elements in the layer of circumferential reinforcing elements are made of metal and/or textile and/or glass.

19. The tire according to claim 17, wherein the reinforcing elements in the layer of circumferential reinforcing elements have an elastic modulus in excess of 6000 N/mm².

20. The tire according to claim 16, wherein the reinforcing elements in the working layers are made of a textile material.

21. (canceled)
